(19) United States
(12) Patent Application Publication
(10) Pub. No.: US 2021/0174633 A1
(43) Pub. Date: Jun. 10, 2021

(54) METHOD OF AND GAMING SYSTEM FOR PLAYING A SYMBOL MATCHING GAME

(71) Applicant: Novomatic AG, Gumpoldskirchen (AT)

(72) Inventors: Ján KOCÚR, Poprad (SK); Lukás TOMONDY, Kosice (SK); Matej KIRAL'VARGA, Kosice (SK); Marek MACHÁCEK, Miloslavov (SK)

(21) Appl. No.: 16/953,818

(22) Filed: Nov. 20, 2020

Related U.S. Application Data
(63) Continuation of application No. 16/531,304, filed on Aug. 5, 2019.
Application No. 16/531,304 is a continuation of application No. 15/829,301, filed on Dec. 1, 2017, now abandoned.

(51) Int. Cl. G07F 17/32; G07F 17/34

(52) U.S. Cl. CPC G07F 17/3213; G07F 17/3246; G07F 17/3209; G07F 17/34

(57) ABSTRACT

A system apparatus and method which provides a player of a gaming system the ability to wager on accepted move inputs, wherein such move inputs cause like symbols to be removed from the symbol arrangement and replaced with new symbols, and wherein awards are provided when the such removed symbols allow for reward symbols to be released.

### CROSS-REFERENCE TO RELATED APPLICATIONS

This application is a continuation of U.S. application Ser. No. 16/531,304, filed Aug. 5, 2019, which is a continuation of U.S. application Ser. No. 15/829,301, filed Dec. 1, 2017, the contents of which are hereby incorporated by reference herein in their entirety.

### BACKGROUND OF THE INVENTION

### Field of the Invention

The present disclosure relates to improvements to gaming systems and gaming machines. In one example, the present disclosure provides an improved game for a wagering gaming system, such as a casino slot machine.

### Description of the Related Technology

Gaming machines, such as slot machines, video poker machines, and other mechanical, electromechanical, and electronic machines used to determine and/or display wagering game outcomes have become an integral part of the worldwide gambling industry. Often, the commercial success of such gaming machines is heavily reliant on their methods of determining the gaming outcomes, and their methods of displaying the gaming outcomes. These methods must be statistically reliable, but typically must also be easily understood by a player, and entertaining, in order to prove successful.

More recently, gaming machines are being configured to be more interactive with the player, allowing the player to make inputs which affect or appear to affect the outcome. This interactive nature creates unique problems in that gaming machines remain a highly regulated device, with such regulations pertaining to payback percentage or hold of the gaming machine, and the prevention of cheating and/or “gaming” of the device for the benefit of gaining a higher payback. It is highly desirable to provide both an interactive gaming experience while retaining the reliability and predictability of traditional slot machines.

### SUMMARY

The present disclosure endeavors to solve such problems, and relates to a gaming system comprising a display device, a bill acceptor, a user interface device, at least on processor device, and at least one memory device storing a plurality of instructions. In one embodiment, the plurality of instructions, when executed by the at least one processor device, cause the at least one processor device to receive a confirmation from the bill acceptor that a physical indicia of monetary value was validly accepted, cause the display device to display a symbol arrangement of symbols, and receive from the user interface device a desired move input from a player. The system is additionally configured to determine whether the desired move input would cause a first plurality of symbols to meet predefined match criteria, and when the desired move input would cause the first plurality of symbols to meet the predefined match criteria, cause a wager to be placed and cause the display device to display a move of at least two symbols in accordance with the desired move input. Further, the system may determine a type of match for the first plurality of symbols, cause the display device to display the removal of the first plurality of symbols, and when the type of match is determined to meet a predefined destroyer criteria, cause the display device to display the removal of at least one additional symbol. The system may also be configured to cause the display device to display a movement of symbols to reconstitute the symbol matrix, determine whether a first reward symbol was released by the reconstituted symbol arrangement, and when the first reward symbol was released, determine an award based on the wager and the first reward symbol, and provide the award to the player.

In additional embodiments, the gaming system may be configured to determine whether the reconstituted symbol arrangement causes a second plurality of symbols to meet the predefined match criteria, and when the reconstituted symbol arrangement causes a second plurality of symbols to meet the predefined match criteria, determine the type of match for the second plurality of symbols and cause the display device to display the removal of the second plurality of symbols. Further, when the type of match is determined to meet the predefined destroyer criteria, cause the display device to display the removal of at least one additional symbol, cause the display device to display another reconstituted symbol arrangement, determine whether a second reward symbol was released by the reconstituted symbol arrangement, when the second reward symbol was released, determine a subsequent award based on the wager and the second reward symbol, and provide the subsequent award to the player.

In another embodiment, the gaming system may be configured to determine whether the displayed symbol arrangement of symbols allows for any desired move input to cause any plurality of symbols to meet the predefined match criteria, and when it is determined that any desired move input would not cause any plurality of symbols to meet the predefined match criteria, cause the display device to display the symbol arrangement with different symbols.

Corresponding methods and non-transitory machine-readable storage medium storing corresponding instructions are also disclosed herein.

It is therefore an object of the present disclosure to teach a gaming system that allows player interaction, while also allowing for predictability in payback percentage/hold. This, and other benefits, are inherent from the present disclosure.

### BRIEF DESCRIPTION OF THE DRAWINGS

FIG. 1 is a frontal view of an exemplary gaming machine, in accordance with an embodiment of the present disclosure.

FIG. 2 is a schematic view of a gaming machine, in accordance with an embodiment of the present disclosure.

FIG. 3 is a flowchart illustrating how a gaming system, in accordance with an embodiment of the present disclosure, would be configured.

FIGS. 4A, 4B, 4C, 4D, 4E, 4F, and 4G are graphical user interface views of one embodiment disclosed herein of a gaming device configured with Destroyer symbols.

FIGS. 5A, 5B, 5C, 5D, 5E, 5F, 5G, 5H, 5I, 5J, 5K, and 5L are graphical user interface views of one embodiment disclosed herein of a gaming device configured with Reward symbols.

FIGS. 6A, 6B, 6C and 6D are exemplary symbol arrangements, in accordance with various embodiments disclosed herein.

FIGS. 7A, 7B, and 7C are exemplary play field arrangements, in accordance with various embodiments disclosed herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples consistent with the description; however, the description is not limited to the examples provided in the drawings.

### DETAILED DESCRIPTION OF CERTAIN INVENTIVE EMBODIMENTS

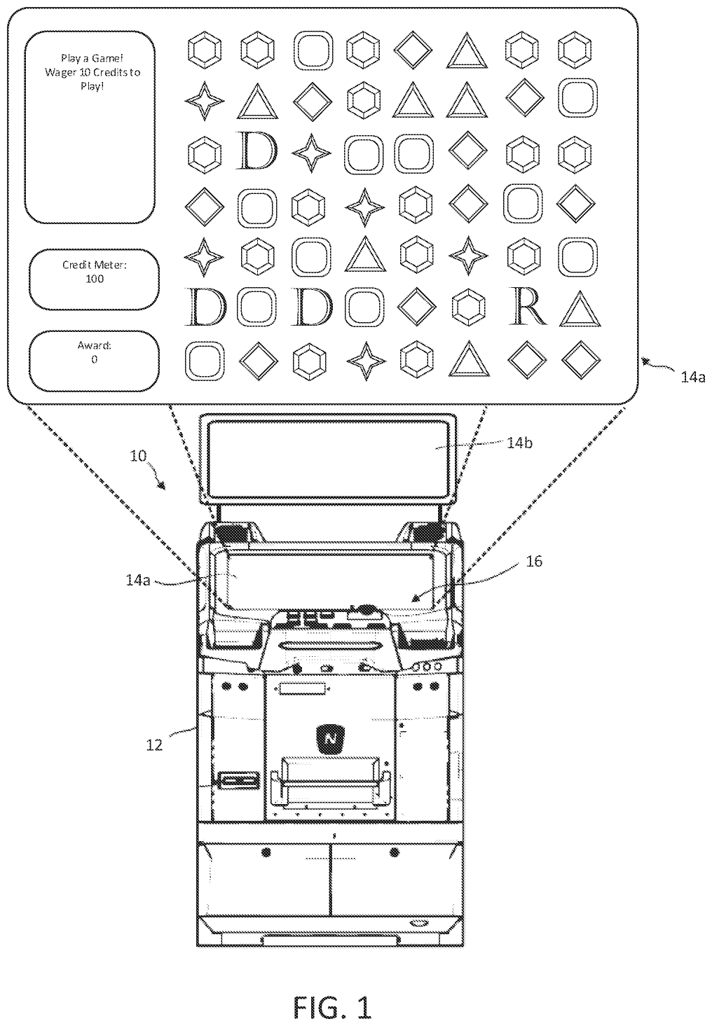

Referring to FIG. 1, a typical gaming machine 10 is shown. Gaming machines are sometimes referred to as a gaming system, slot machines, electronic gaming machines (EGM's), poker machines, pokies, video lottery terminals (VLT's), gaming terminals, video slot machines, and video gaming machines, and all such machines typically operate in a similar manner in that a player places something of value at risk on an outcome that is unknown and uncertain to the player, and the machine displays the associated outcome, thereby informing the player of the resolution associated with their placing said something at risk.

The gaming machine 10 includes a housing 12 with a lower display 14a, an upper display 14b and a user interface 16. In one embodiment, lower display 14a and upper display 14b are the same type of display. In another embodiment, lower display 14a and upper display 14b are different types of displays. Such displays could be a flat-panel display, such liquid crystal display (LCD), light emitting diode (LED) display, organic light emitting diode (OLED) display, quantum dot light emitting diode (QLED), plasma display, or an LCD pixel matrix. It is also contemplated that other, non-flat-panel display devices could be used, such as cathode ray tube (CRT) or a projection display system such as digital light processing (DLP), LCD projector, or liquid crystal on silicon (LCoS) projector.

In a further embodiment, user interface 16 comprises physical buttons. In another embodiment, user interface 16 comprises a touchscreen. In still a further embodiment, user interface 16 is located apart from each of the lower display 14a and upper display 14b. in another embodiment, user interface 16 appears to be part of, and is co-located with, the lower display 14a and/or upper display 14b. For example, user interface 16 is a touchscreen over the lower display 14a.

FIG. 1 further illustrates an example graphical user interface (GUI) or screenshot of lower display 14a, in accordance with one embodiment.

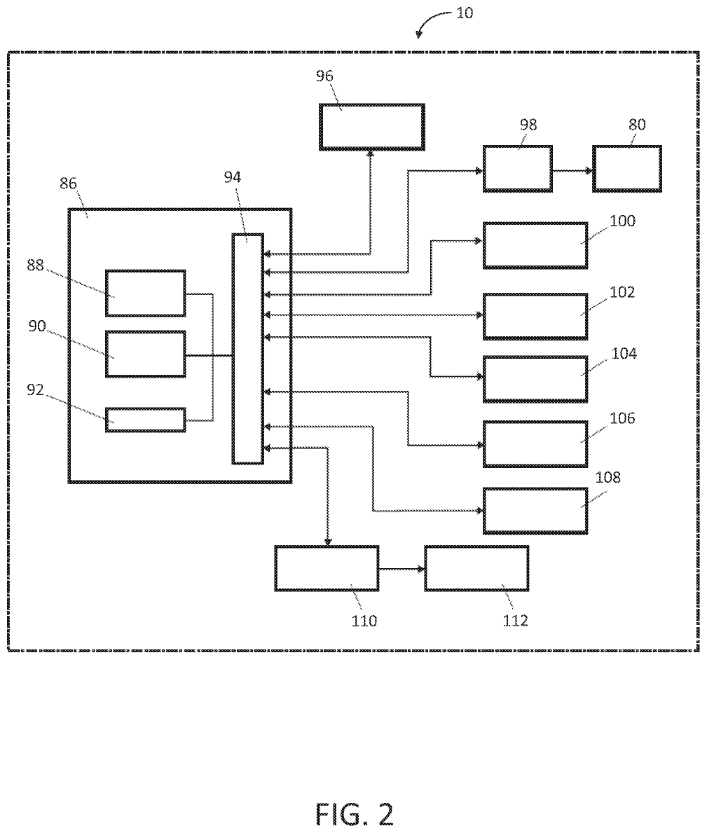

FIG. 2 is a schematic diagram of a gaming system in accordance with one embodiment of the present disclosure. The gaming machine 10 includes a main board 86, program memory 88 being a computer readable medium, a main processor 90 and random access memory (RAM) 92 connected in operative communication. Gaming machine 10 has an input output (I/O) controller 94. The I/O controller 94 communicates with a user interface control panel 96 that may be part of the user interface 16, a display interface driver circuitry 98, a display unit 100, a coin acceptor 102, a bill acceptor 104, a card reader 106, a ticket reader/printer 108, and a sound circuit 110. The sound circuit 110 is in operative communication with speakers 112.

In some embodiments, program memory 88 stores program code that is executable by the main processor 90. Program memory 88 may also store operating data, such as a (pseudo) random number generator (RNG), game instructions, event data, display files, game history data, and other such data and instructions that allow for a gaming device to properly function in a regulated gaming environment.

Display interface circuitry 98 is connected in operative communication with display 80. Display 80 may comprise multiple displays, such the lower display 14a and upper display 14b. Display 80 may also comprise a touchscreen-interface being operatively connected with the interface control panel 96 or I/O controller 94.

The coin acceptor 102 and the bill acceptor 104 accept currency and communicate the amount accepted to the I/O controller 94. The card reader 106 reads credit cards, debit cards, gift cards or other card having electronic indicia of monetary value. In one embodiment, card reader 106 is configured to interact with a radio frequency identification (RFID), WiFi, Bluetooth, and/or Near Field Communication (NFC) devices which can transmit financial information short distances, for example a bracelet, smart watch, smart phone, or other similar devices.

The ticket reader 108 prints tickets and receipts revealing the winnings of a player, or other financial outcome. The ticket reader 108 also receives tickets having indicia of monetary value, such as a bar code or QR-code, which is read by the ticket reader 108. In one embodiment, bill acceptor 104 is configured to also be a ticket reader 108. In another embodiment, ticket reader 108 or bill acceptor 104 is configured to also be a card reader 106.

The sound circuit 110 is configured to provide an acoustic-based interface for the user. Each movement or action by a user may result in a particular sound, or instruction being generated by the computer 84. The speakers 112 communicate the sounds to the user.

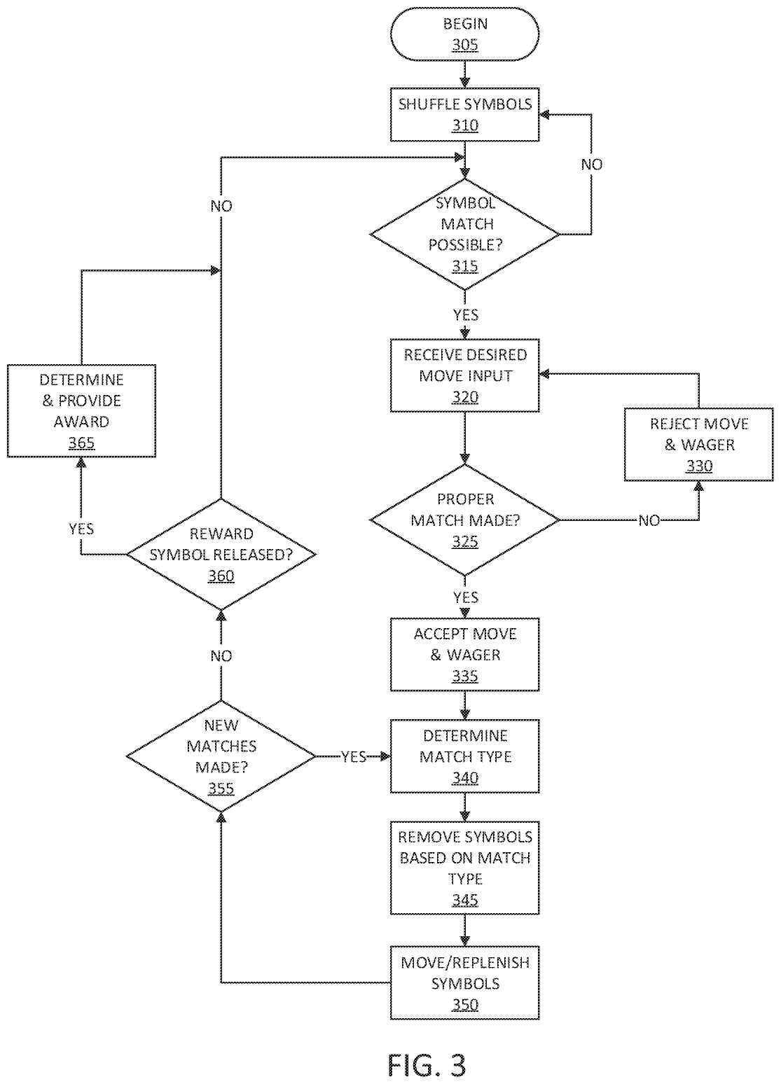

Referring to FIG. 3, a flowchart of how one embodiment of the present disclosure may be configured is discussed. At step 305, the process begins. In one example, the gaming system detects the presence of a player through the user interface 16. In another example, the gaming system detects the insertion of a physical indicia of monetary value, such as physical money (e.g., paper money or coins), or a ticket representing a monetary value, or a card presentative of monetary value or monetary credit.

At step 310, game symbols are shuffled and displayed to the player at the lower display 14a or upper display 14b. In one example, game symbols are shuffled based on a randomly generated number from the RNG. In another example, game symbols are selected from a predefined set of starting configurations. In a further example, the game symbols are displayed as cascading down the display and stacking from the bottom to the top of the screen. In another example game symbols are displayed to appear as to simultaneously appear at their individual locations.

At step 315, the gaming system determines if a symbol match is possible. If a symbol match is not possible, then the system reverts back to step 310 for a new shuffle of the symbols. If a symbol match is possible, then the gaming system proceeds to step 320 to receive a desired move input from the player using the user interface 16, such as the touchscreen interface. In one embodiment, the gaming system receives a desired move input from the player when the player indicates on the touchscreen that they desire two symbols to swap locations, as described below.

At step 325, the gaming system determines whether or not the received input results in a proper match. If the received input does not result in a proper match, then the gaming system rejects the move and wager at step 330, and reverts back to step 320. For example, the player may have input a move that would not have resulted in a minimum number of matches, such as three, and therefore was not a proper match.

If at step 325 the gaming system determines that a proper match was made, the gaming system then accepts the move and the corresponding wager. For example, if the player had indicated a move that would have created a match of three like symbols, the gaming system would have determined that such a match is acceptable, and then accepted the move and wager.

In one embodiment, the wager is a monetary wager, wherein a monetary amount is put at risk on a yet-undecided outcome. In another embodiment, a wager is not placed but rather a virtual wager is placed, wherein a virtual currency with no real-world cash value, is placed at risk. In such an example, a player may buy or be awarded such virtual currency to play with, but is not allowed to exchange such virtual currency for monetary value. Another such example is the implementation of the disclosed methods in a social gaming arrangement, either online, and/or remotely via a personal electronic device of a player, such as a smartphone or tablet.

At step 340, the gaming system determines the match type. In one embodiment, the gaming system compares the match to predefined match criteria and/or predefined destroyer criteria. For example, the match type could be a basic match type of three like symbols. In another example, the match type could be a Destroyer match type, as discussed in more detail below, which results in additional symbols being removed.

At step 345, the gaming system removes the symbols based on the determined match type, and at step 350, the gaming system 350 move and replenishes the game symbols to replace the removed symbols from step 345. In one example, the symbols located above the removed symbols are displayed as falling or cascading down to replace the removed symbols, and new symbols are displayed and filling into the newly vacated positions of the newly cascaded symbols. It is noted that the terms “above”, “below”, “up”, “down” are relative terms to respectively describe relative positions of the items displayed, merely in relation to opposite edges of the display, rather than referencing to physical laws of nature.

At step 355, the gaming system determines if the new arrangement, or reconstituted arrangement, of displayed symbols, caused by step 350, results in new matches of symbols.

If it does result in new matches, gaming system returns to step 340. In such an configuration, one or more loops of steps 355 back to 340 and back to 355, a cascading action, or chain reaction, is achieved. If and/or when the gaming system determines that no new matches are made, it proceeds to step 360. In another embodiment, the gaming system executes steps 355 and 360 in parallel instead of in series.

At step 360, the gaming system determines if a Reward symbol was released, as discussed in more detail below. If a Reward symbol was released, gaming system determines and provides an award at step 365. In one embodiment, there are multiple different kinds of Reward symbols, and the determined award is based on the kind and/or number of Reward symbols released. In a further embodiment, the generation of Reward symbols is based on a (pseudo) random number from the RNG. In another embodiment, symbol matches that meet certain predefined match criteria generate new Reward symbols to automatically be displayed as part of the symbol arrangement. For example, a match of five like symbols can automatically generate one new Reward symbol to appear at one of the locations of the five like symbols, while removing the remaining four like symbols. In still a further embodiment, the type of Reward symbol to be displayed is based on a (pseudo) random number from the RNG. In another embodiment, each of the displayed symbols is based on a (pseudo) random number from the RNG. In a further embodiment, certain of the displayed symbols is based on predefined patterns of symbols stored in one or more memory devices. In still another embodiment, part of a symbol arrangement of symbols is based on predefined patterns while another part of the symbol arrangement of symbols is based on a (pseudo) random number from an RNG. For example, the gaming system may utilize a predefined pattern of non-Reward symbols which have openings for Reward symbols, and rely on the RNG to determine the type of Reward symbol to display in such openings. In another embodiment, any determined award is credited to a displayed credit meter at the gaming system, and may be subsequently cashed out by the player, or wagered again on another move.

If no Reward symbol was released, or after any award is determined, gaming system returns to step 315 to determine if another symbol match is possible.

In the present embodiment, it is noted that the player wagers for each chance to make an acceptable move. It is contemplated that in such an embodiment, the player will perceive a benefit in wagering when they know there will be a match, and where they control the match and the subsequent symbol removal, and therefore a perceivable chance at a guaranteed reconstituted symbol arrangement that they have some control over. It is also noted that the player only receives an award when a Reward symbol is released, which provide operators more control over the regulated aspects of the gaming system, and particularly payback percentage/hold.

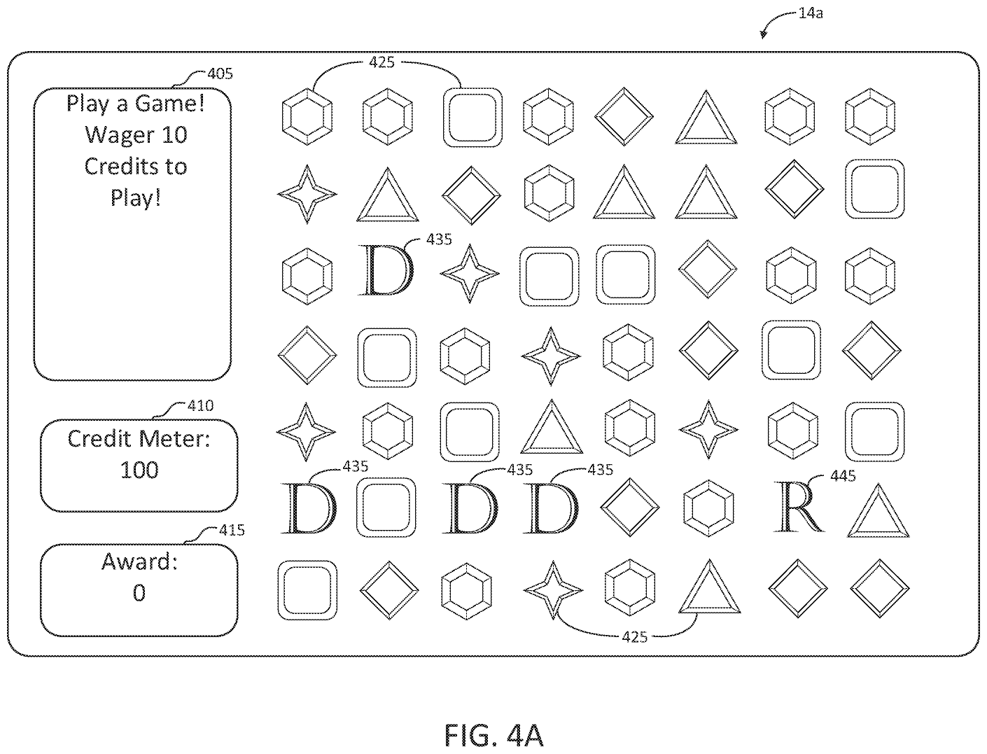

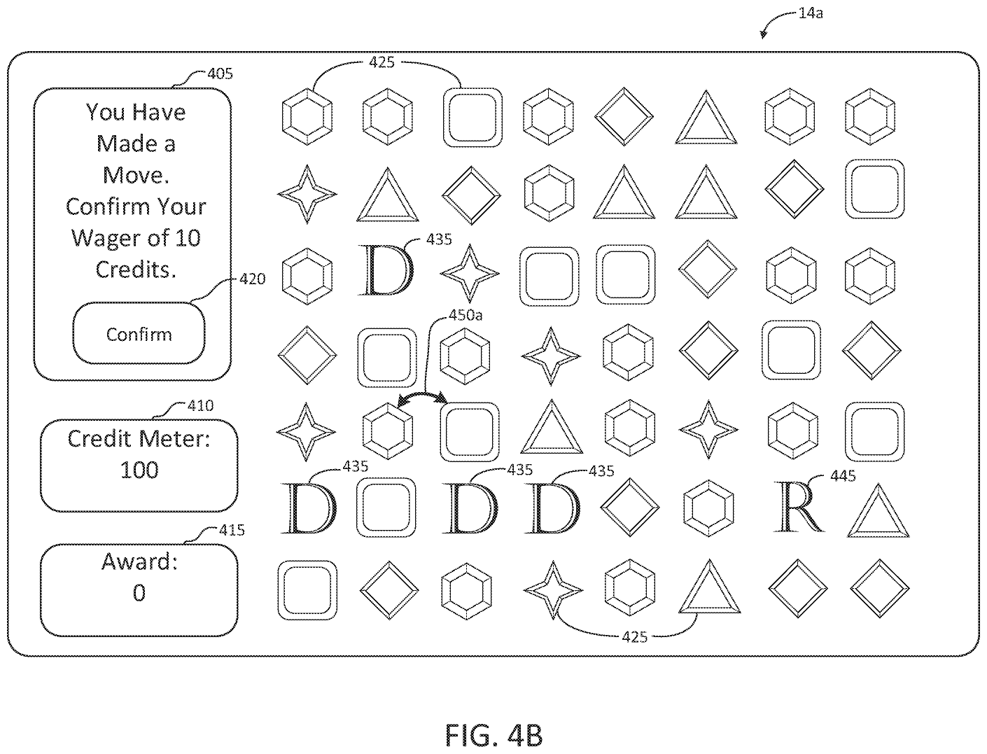

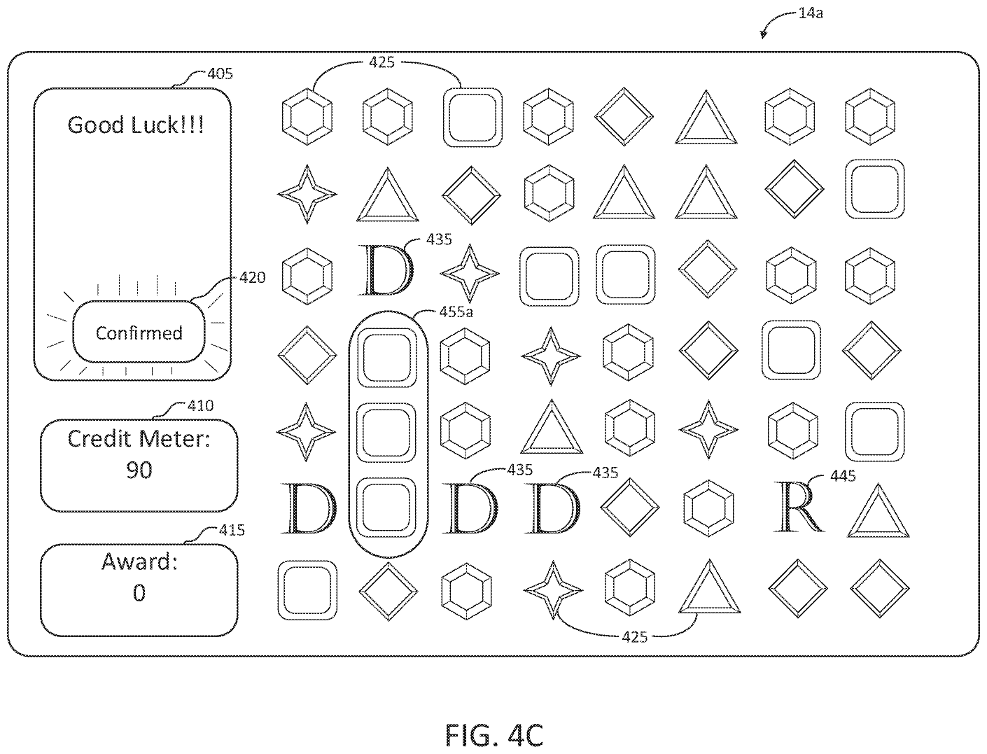

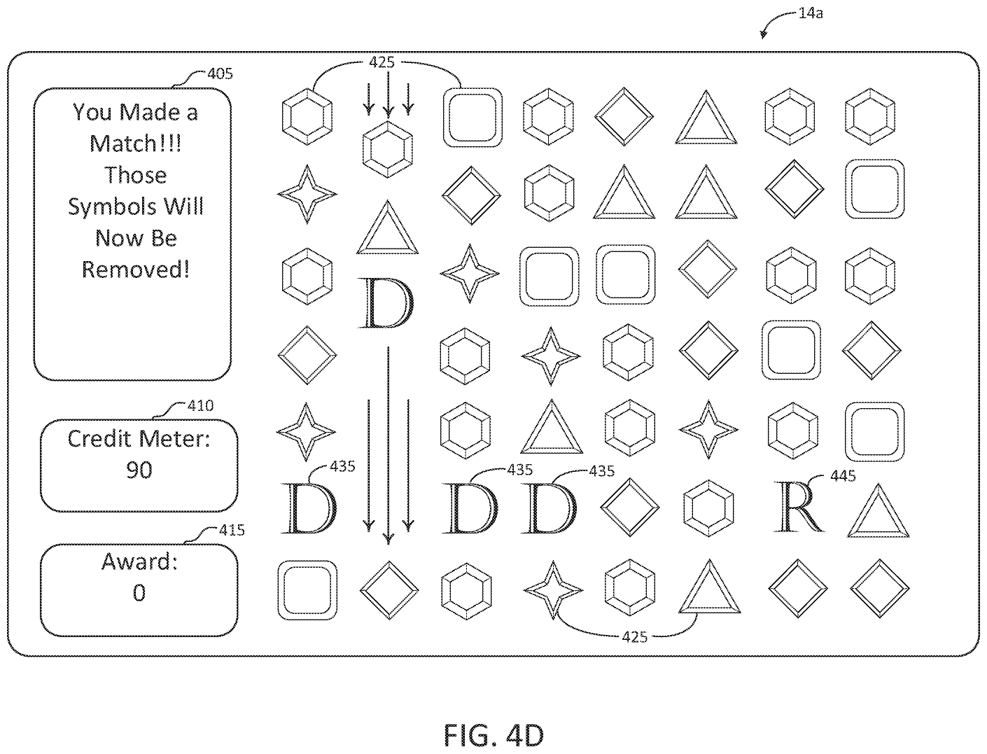

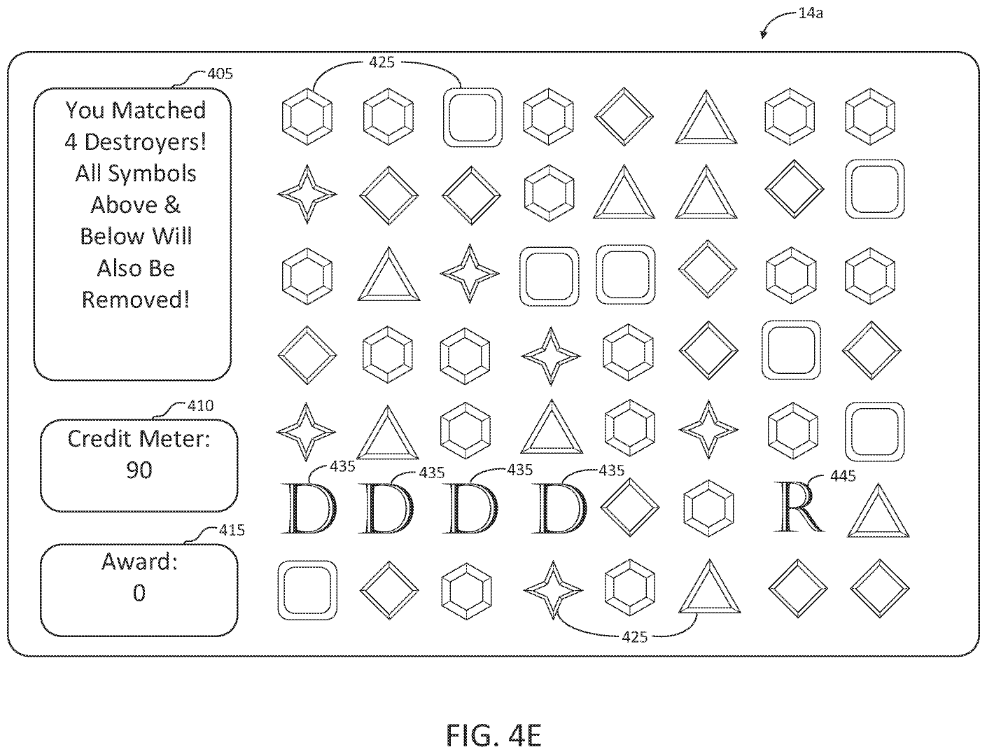

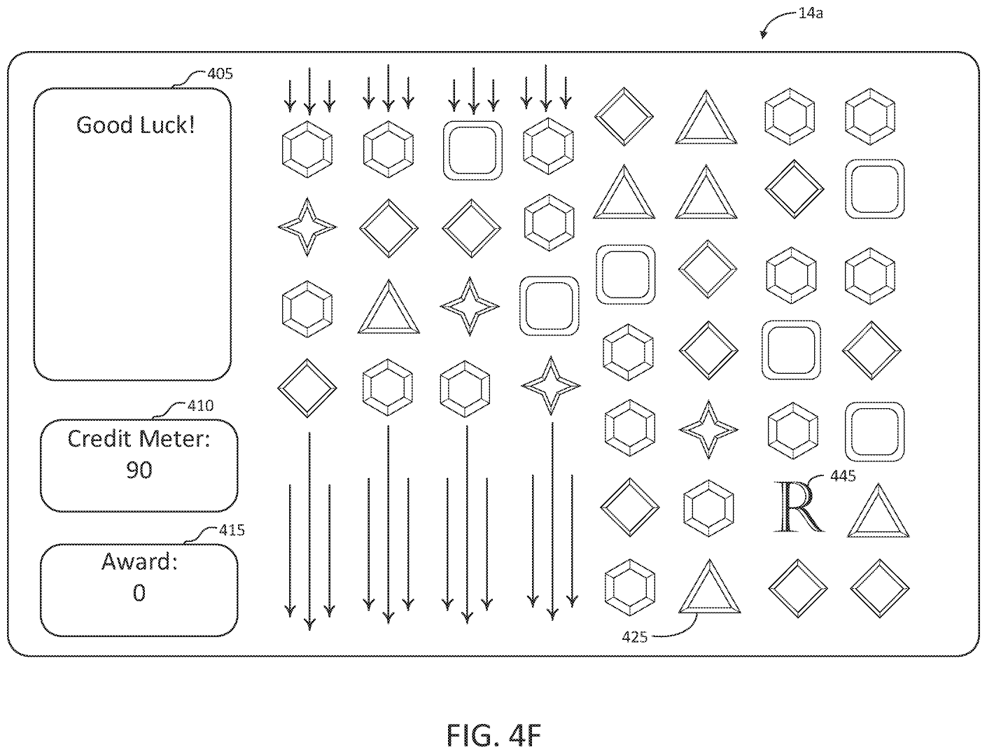

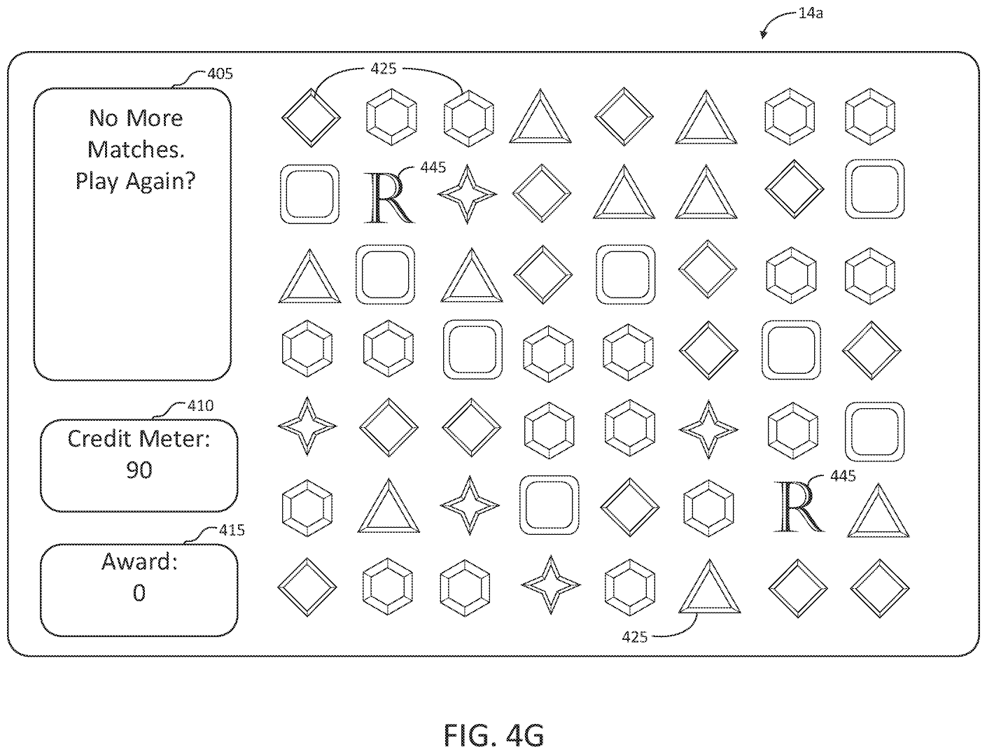

FIGS. 4A through 4G illustrate an example of how a gaming system, configured in accordance with FIG. 3, might operate through different states. FIG. 4A illustrates lower display 14a displaying a player messaging interface 405, a credit meter 410, and an award meter 415. The present embodiment also includes a symbol arrangement which comprises standard symbols 425, Destroyer symbols 435, and Reward symbols 445 arranged in a matrix respectively array. In FIG. 4A, player messaging interface 405 provides the message “Play a Game! Wager 10 credits to Play!” Credit meter 410 indicates that the player has inserted or otherwise accrued one hundred (100) credits.

FIG. 4B illustrates that the player has input a desired move 450a, which is a change or swap of position or place of two neighboring or adjacent symbols in this case such that one symbol takes the position of the other symbol and vice-versa. It is contemplated that the desired move may swap any two symbols within a predefined distance, as provided for by controlling rules, to create a valid combination. For example, the distance may be one (1) as illustrated with move 405a, however the distance might be two (2) or three (3) or any other integer value meaningful within the arrangement. Player messaging interface 405 provides the message “You Have Made a Move. Confirm Your Wager of 10 Credits.” Player messaging interface 405 also provides a “Confirm” button 420 for the player to confirm their wager. In one embodiment, the player is not asked to perform the additional step of confirming their wager. In a further embodiment, the wager is confirmed automatically, for example when the player makes the initial input of a desired move.

FIG. 4C illustrates that the player has pressed the Confirm button 420, and the credit meter is illustrated as having been decremented from one hundred (100) credits to ninety (90) credits, to account for the wager confirmed by the player. The symbols are also illustrated as having been swapped, which results in a proper match 455a of three of the same type of symbol now being arranged in a row or stack.

FIG. 4D illustrates removal of the matched symbols 455a from FIG. 4C, and the moving of the remaining of symbols as generally indicated by the “triple” arrows. Player messaging interface 405 also provides notification to the player that “You Made a Match!!! Those Symbols Will Now Be Removed!”

FIG. 4E illustrates the entire symbol arrangement being reconstituted, and that the result was a match of four Destroyer symbols 435. Player messaging interface 405 informs the player that “You Matched 4 Destroyers! All Symbols Above and Below Will Also Be Removed!”

FIG. 4F illustrates that the four Destroyer Symbols 435 of FIG. 4E, and all symbols directly adjacent above and below the Destroyer symbols, were removed, and the symbols located above the removed symbols are displayed as cascading down to replace the removed symbols. Also note that credit meter 410 was not decremented, as the illustrated symbol removals was still as a result of the initial credits wagered by the player.

FIG. 4G illustrates the reconstituted symbol arrangement, but does not display a new proper match (in this example, a match of at least three symbols of the same type, arranged in a row or stack, is a proper match), and so player messaging interface 405 provides the message of “No More Matches. Play Again?”

In the exemplary embodiment illustrated in FIGS. 4A to 4G, Destroyer symbols 435 are illustrated as a distinct symbol. In one embodiment, any symbol can be a Destroyer symbol, and the functionality of the Destroyer symbol is based on there being a requisite number included as part of the match. For example, a diamond symbol may act as a standard symbol 425 for matches of three diamond symbols, but may act as a Destroyer symbol 435 for matches of four or more diamond symbols. In another embodiment, the functionality of the Destroyer symbol is based on the type of match it is included in. For example, a match of four Destroyer symbols 435 may result in the removal of the Destroyer symbols plus an additional number of other symbols, and a match of five Destroyer symbols 435 may result in the removal of the Destroyer symbols plus an additional number of a different group of other symbols. It is contemplated that a match of Destroyer symbols results in the removal of the Destroyer symbols involved in such a match, as well as additional symbols not involved in such a match.

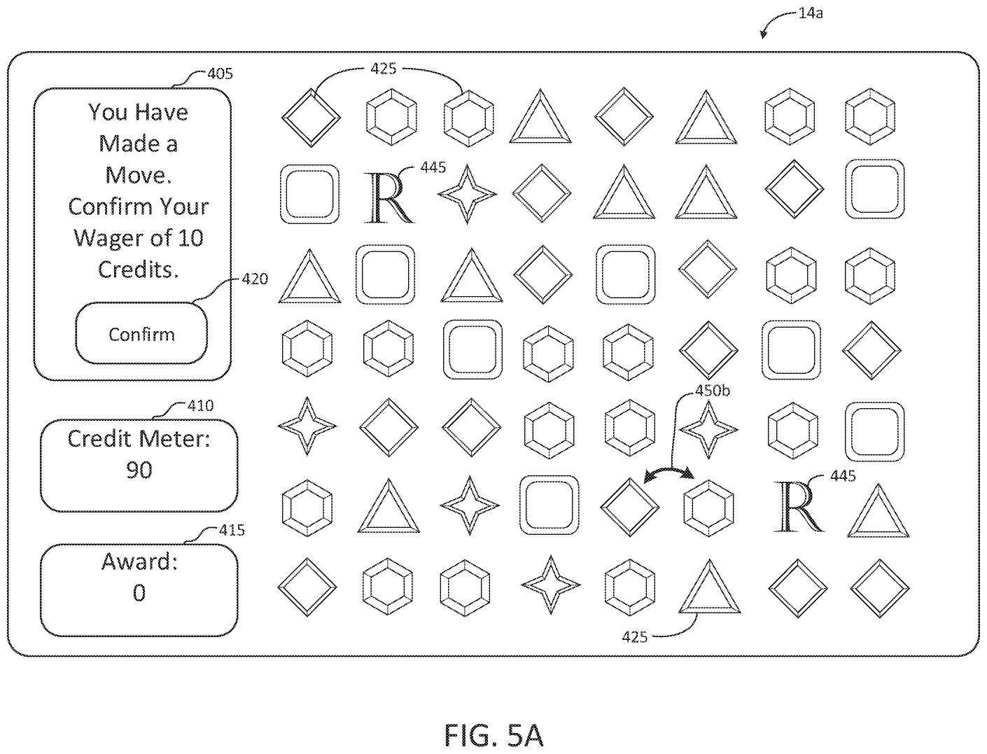

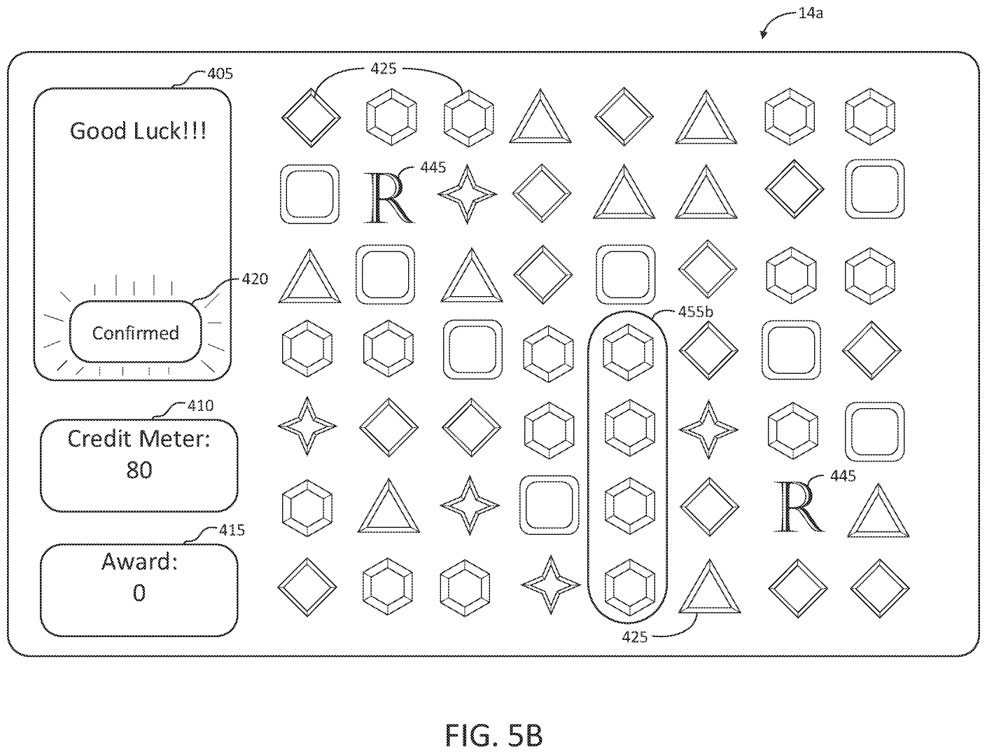

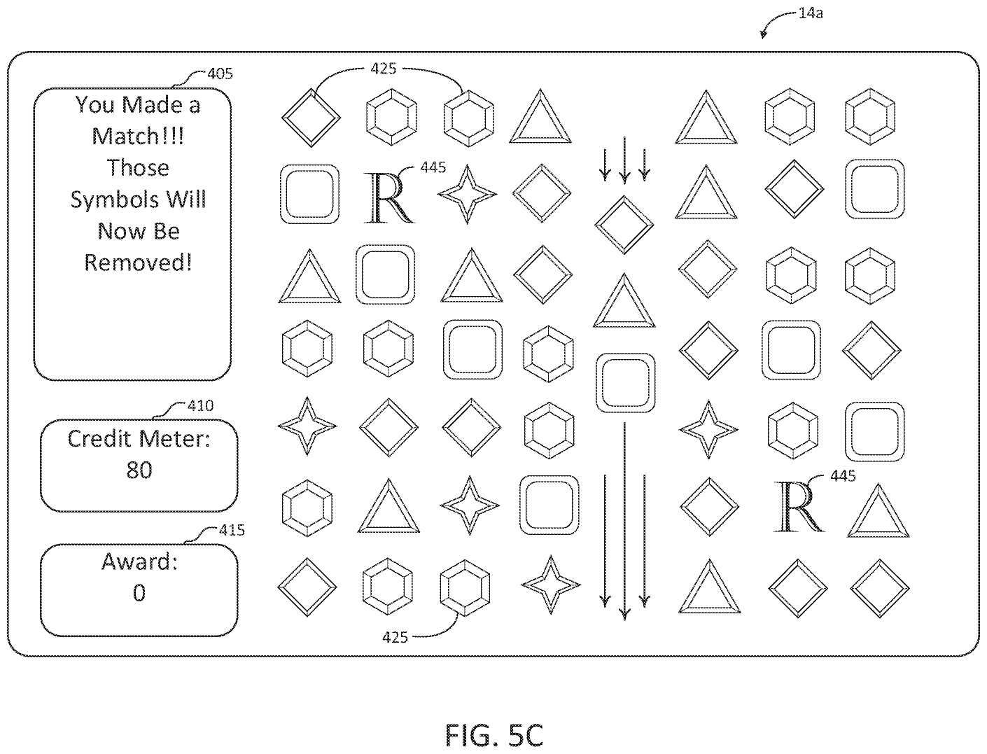

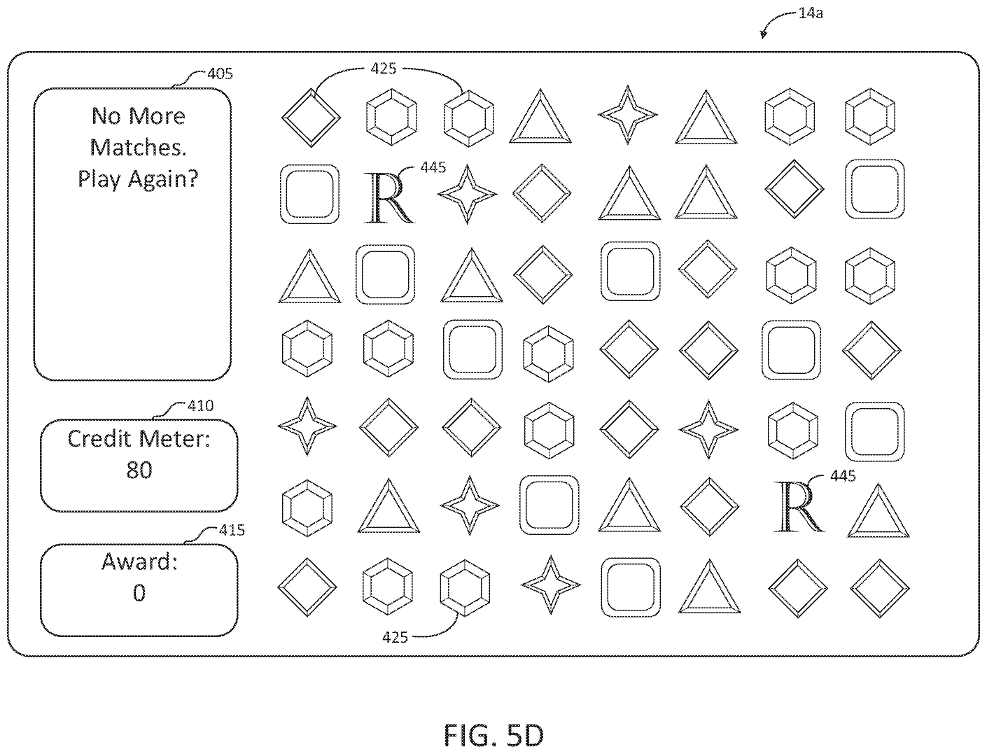

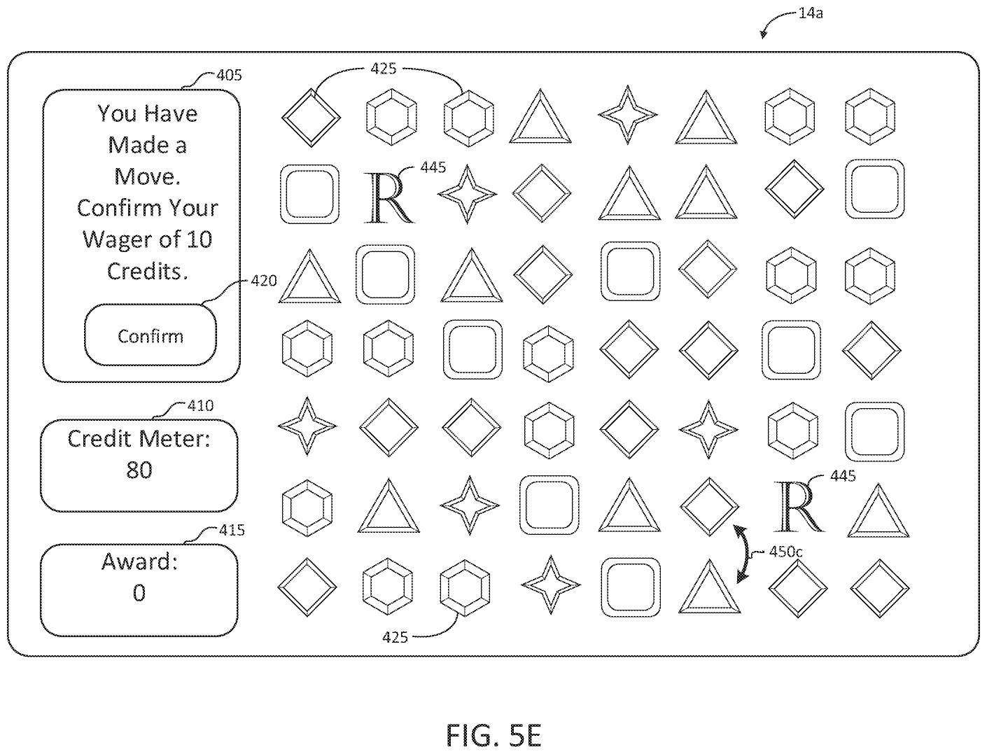

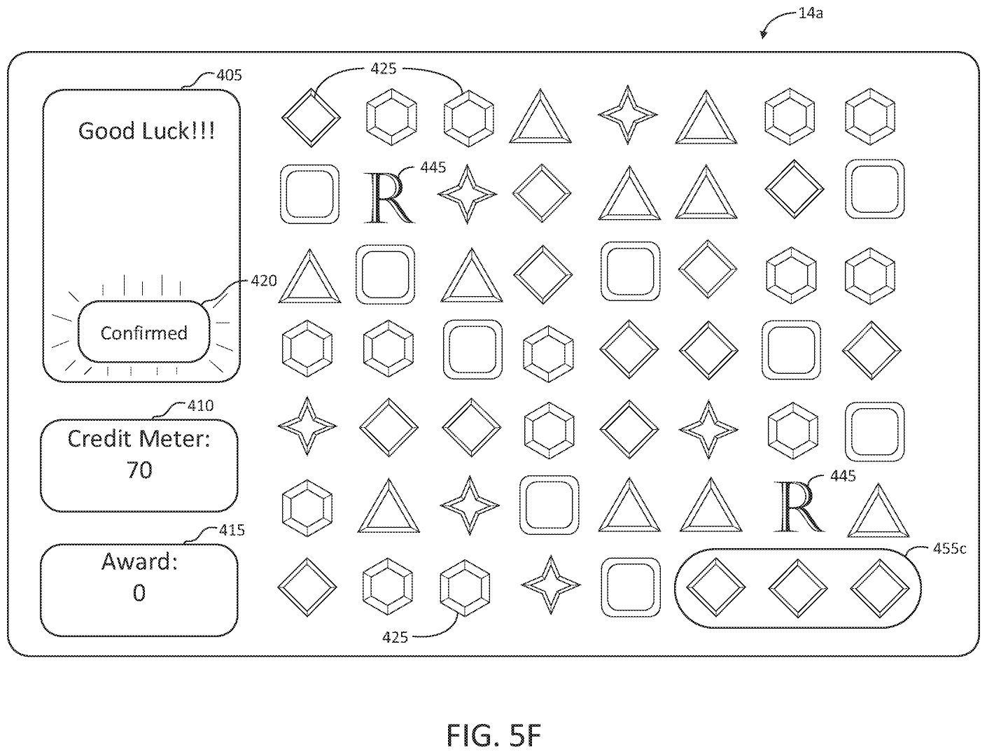

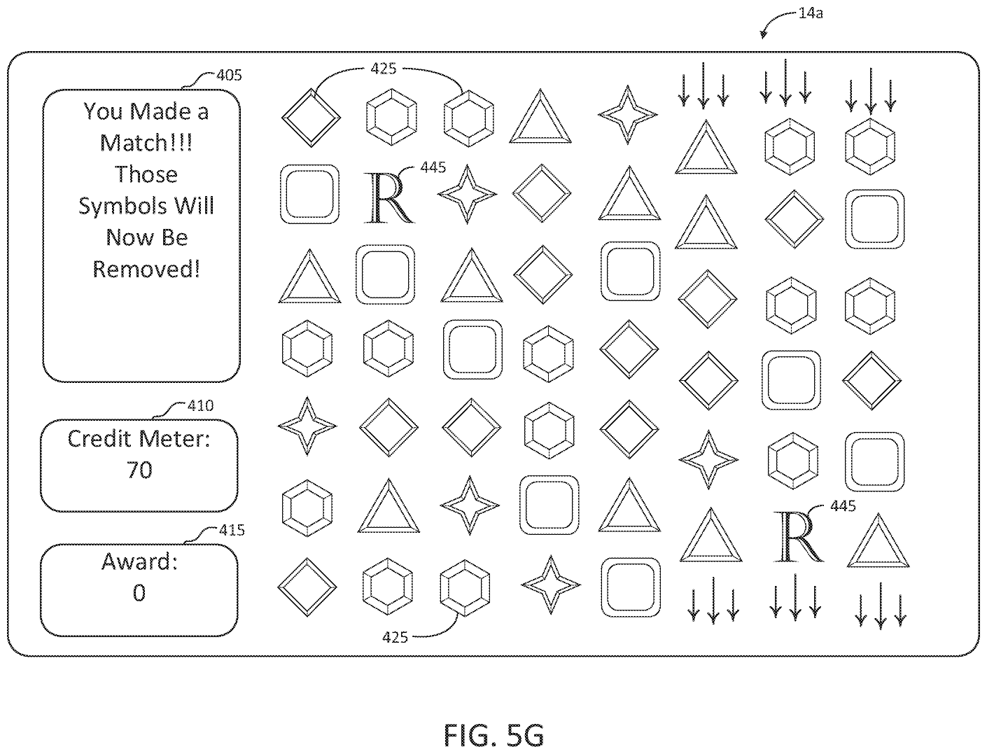

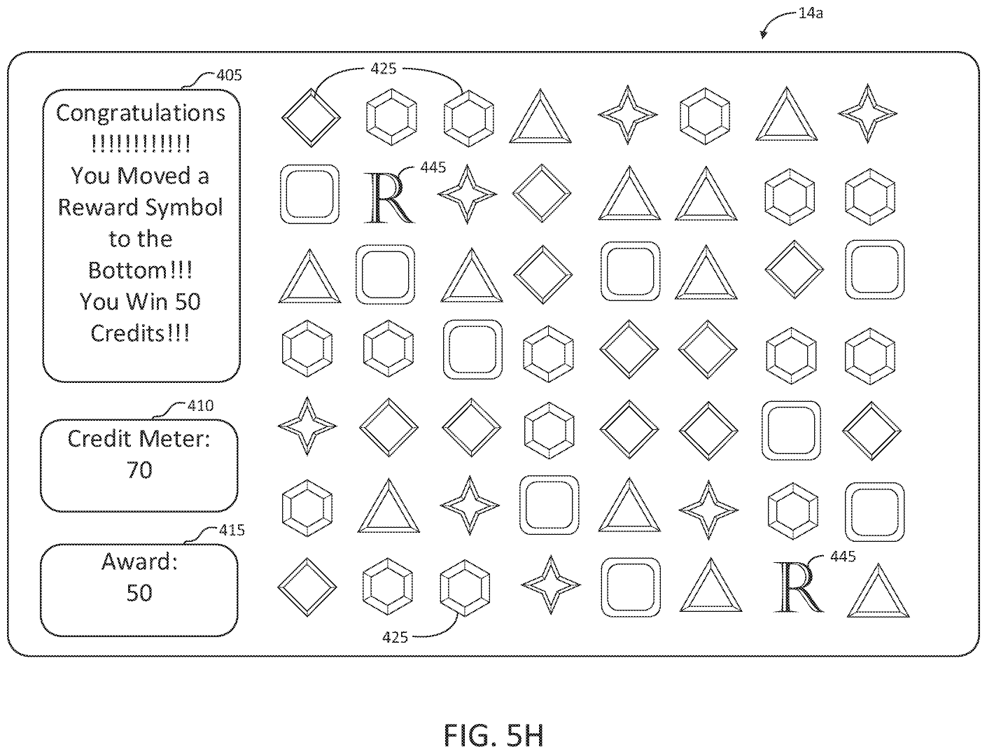

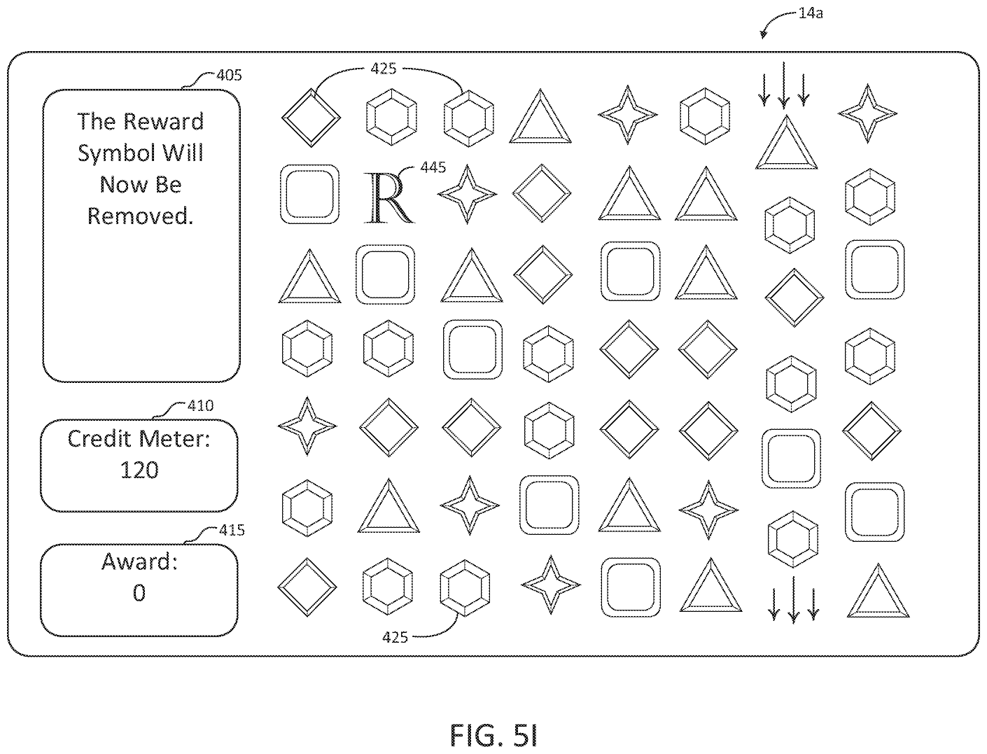

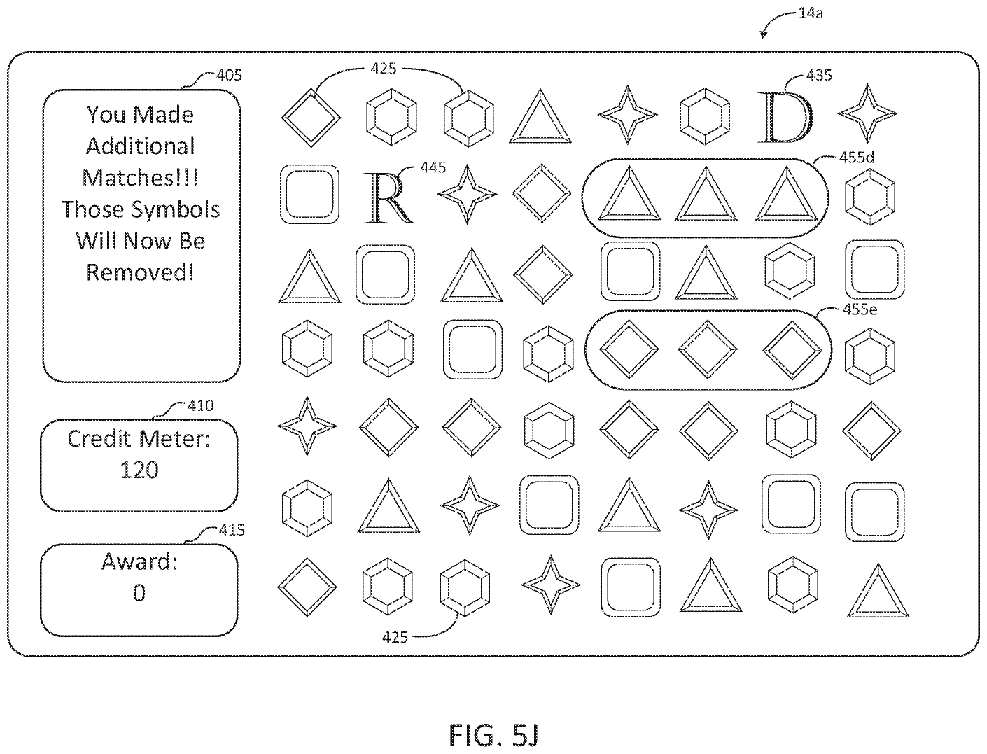

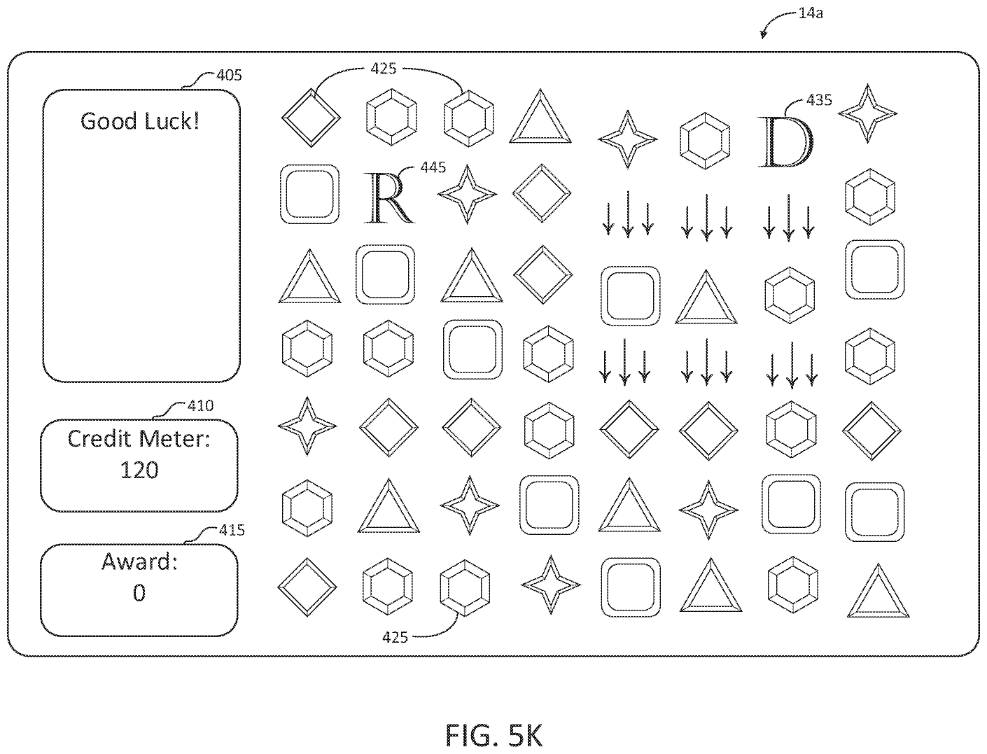

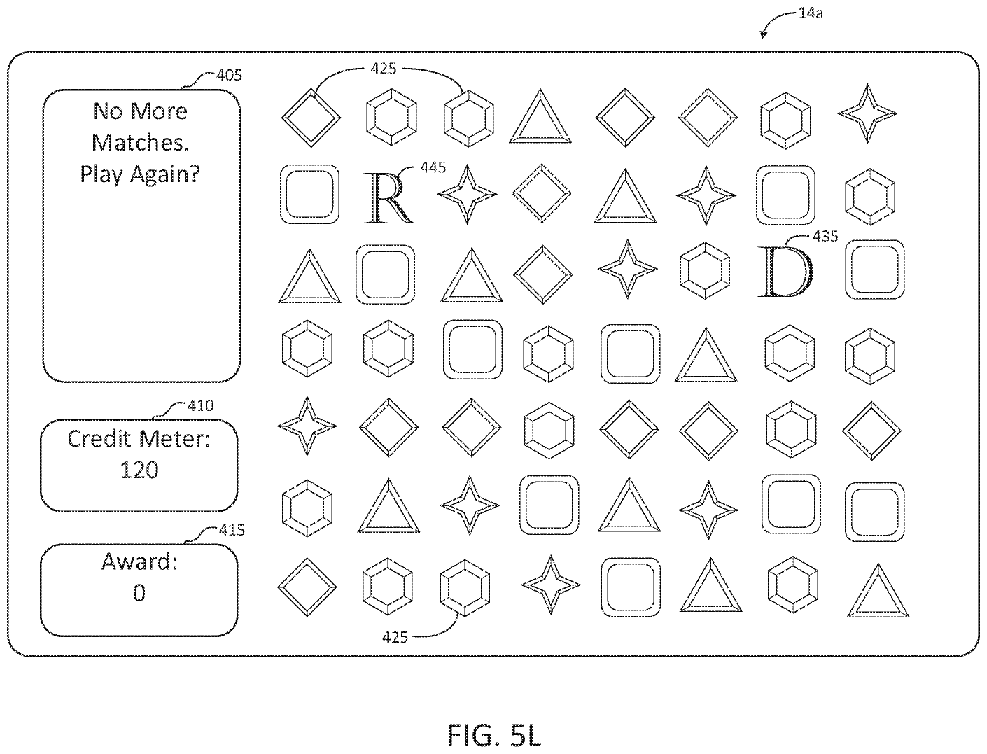

FIGS. 5A to 5L illustrate an example of how a gaming system, configured in accordance with FIG. 3, might operate, and are illustrated as a continuing example from FIGS. 4A to 4G. FIG. 5A illustrates that the player has input a desired move 450b. Player messaging interface 405 provides the message “You Have Made a Move. Confirm Your Wager of 10 Credits.” Player messaging interface 405 also provides a “Confirm” button 420 for the player to confirm their wager. In one embodiment, the player is not asked to perform the additional step of confirming their wager.

FIG. 5B illustrates that the player has pressed the Confirm button 420, and the credit meter is illustrated as having been decremented from ninety (90) credits to eighty (80) credits, to account for the wager confirmed by the player. The symbols are also illustrated as having been swapped, which results in a proper match 455b.

FIG. 5C illustrates removal of the matched symbols from FIG. 5B, and the moving of the remaining of symbols as indicated by the arrows. Player messaging interface 405 also provides notification to the player that “You Made a Match!!! Those Symbols Will Now Be Removed!”

FIG. 5D illustrates the reconstituted symbol arrangement, but does not display a new proper match (in this example, a match of three symbols is a proper match), and so player messaging interface 405 provides the message of “No More Matches. Play Again?” As discussed above, in the present embodiment, only certain symbols can act as Destroyer symbols. In another embodiment, symbol matches of four or more like symbols can act as Destroyer symbols.

In a further embodiment, symbol matches of four or more like symbols create a new Destroyer symbol or symbols. In another embodiment, various numbers of symbol matches of like symbols result in creation of different types of Destroyer symbols. For example, a match of four like symbols can cause the removal of three of the like symbols, while creating a Cross Destroyer symbol, which is configured to destroy all symbols in its row and stack when properly activated (e.g., when properly matched). In another example, a match of five like symbols can cause the removal of four of the like symbols while creating a Bomb Destroyer symbol, which is configured to destroy all symbols within a predefined number of symbol positions (e.g., 3) of the Bomb Destroyer symbol or symbols, when properly activated (e.g., when properly matched). In a further example, such expanded matches (e.g., four like symbols and five like symbols) cause each of the involved symbols to automatically act as such associated Destroyer Symbols (e.g., Cross Destroyer or Bomb Destroyer) without first requiring a change in the symbol appearance and a new match of like symbols.

FIG. 5E illustrates that the player has input a desired move 450c. Player messaging interface 405 provides the message “You Have Made a Move. Confirm Your Wager of 10 Credits.” Player messaging interface 405 also provides a “Confirm” button 420 for the player to confirm their wager. In one embodiment, the player is not asked to perform the additional step of confirming their wager.

FIG. 5F illustrates that the player has pressed the Confirm button 420, and the credit meter is illustrated as having been decremented from eighty (80) credits to seventy (70) credits, to account for the wager confirmed by the player. The symbols are also illustrated as having been swapped, which results in a proper match 455c.

FIG. 5G illustrates removal of the matched symbols from FIG. 5F, and the moving of the remaining of symbols as indicated by the arrows. Player messaging interface 405 also provides notification to the player that “You Made a Match!!! Those Symbols Will Now Be Removed!”

FIG. 5H illustrates a Reward symbol 445 reaching the bottom of the symbol arrangement, which thereby releases the Reward symbol 445. Player messaging interface 405 notifies the player with the informative and congratulatory message “Congratulations!!!!!!!! You Moved a Reward Symbol to the Bottom!!! You Win 50 Credits!! !” Award meter 415 also illustrates the indicated award of fifty (50) credits.

FIG. 5I illustrates that the Reward symbol was removed, and the symbol arrangement was reconstituted as generally illustrated by the “triple” arrows. The credit meter 410 is also illustrated as credit with the fifty (50) credits that were awarded, resulting in the total of one hundred and twenty (120) in this example, and the award meter 415 is reset to the reset value of zero (0).

In one embodiment, there are multiple different kinds of Reward symbols, and the determined award is based on the kind and/or number of Reward symbols released. In a further embodiment, the generation of Reward symbols is based on a (pseudo) random number from the RNG. In another embodiment, symbol matches that meet certain predefined match criteria generate new Reward symbols to automatically be displayed as part of the symbol arrangement. For example, a match of five like symbols can automatically generate one new Reward symbol to appear at one of the locations of the five like symbols, while removing the remaining four like symbols. In still a further embodiment, the type of Reward symbol to be displayed is based on a (pseudo) random number from the RNG. In another embodiment, each of the displayed symbols is based on a (pseudo) random number from the RNG. In a further embodiment, certain of the displayed symbols is based on predefined patterns of symbols stored in one or more memory devices. In still another embodiment, part of a symbol arrangement of symbols is based on predefined patterns while another part of the symbol arrangement of symbols is based on a (pseudo) random number from an RNG. In a further embodiment, a match of Reward symbols or like Reward symbols can create a special Destroyer condition, wherein all symbols below such Reward symbols are removed which would allow for each of the associated Reward symbols to be released. In another embodiment, a match of Reward symbols or like Reward symbols can cause one or more of the associated Reward symbols to be upgraded to a better Reward symbol.

FIG. 5J illustrates the entire symbol arrangement being reconstituted, and that the result was two additional proper matches 455d and 455e. Player messaging interface 405 informs the player that “You Made Additional Matches!!! Those Symbols Will Now Be Removed!”

FIG. 5K illustrates the removal of the matched symbols from FIG. 5J and the reconstitution of the symbol arrangement.

FIG. 5L illustrates the reconstituted symbol arrangement, but does not display a new proper match (in this example, a match of three symbols is a proper match), and so player messaging interface 405 provides the message of “No More Matches. Play Again?”

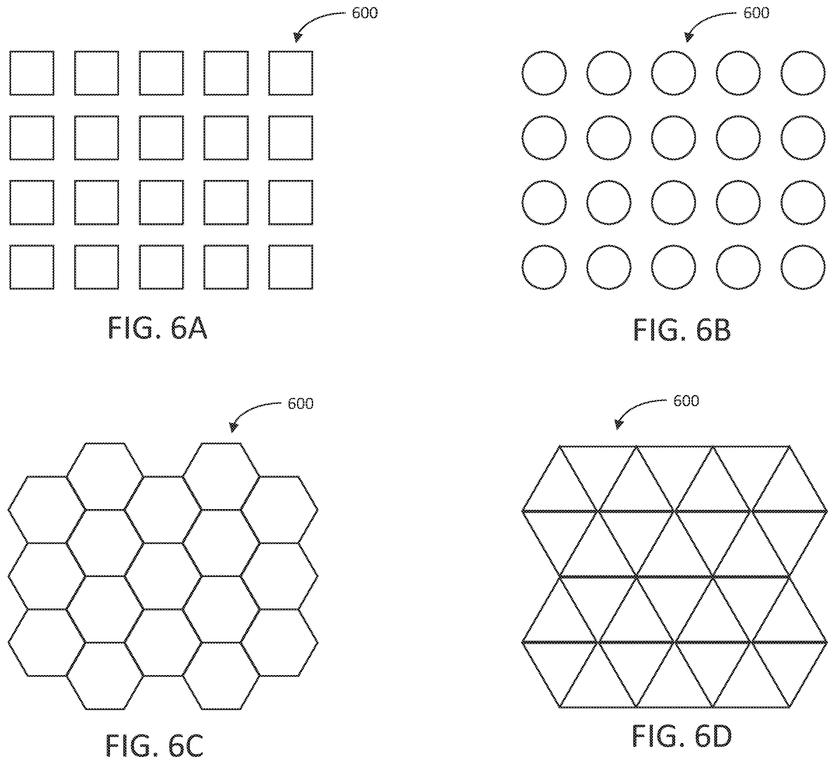

FIGS. 6A to 6D illustrate several of the defined symbol arrangements contemplated herein. FIG. 6A illustrates an arrangement of symbol positions 600 in a four-row by five-column matrix (array), but other symbol arrangements are expressly contemplated herein. FIG. 6B illustrates an additional contemplated symbol arrangement of symbol positions 600, illustrated here with circles rather than squares to represent different symbol orientations and/or cascading properties and/or that the symbols are randomly placed such that the symbols may not have equal distance to each other. In such an embodiment, reconstituting of the symbol arrangement, to replace removed symbols, may be based on predefined cascading patterns that are straight, jagged, curved, or other such predefined patterns. FIG. 6C illustrates a honeycomb symbol arrangement of symbol positions 600 which also illustrates that border areas, such as a top or bottom of a symbol arrangement, need not be linear. FIG. 6D illustrates a triangular symbol arrangement of symbol positions 600, as contemplated herein, and further illustrates that border areas, such as the sides of a symbol arrangement, need not be linear either. FIGS. 6C and 6D also illustrate exemplary embodiments where a proper match of symbols would not require them be in a row or stack, as the symbol positions 600 are not necessarily arranged in rows or stacks. Rather, in these illustrated embodiments, and in the illustrated embodiments comprising matrices, proper matches may only require a prerequisite number of adjacently-positioned like symbols. In one such example, such like symbols are not required to be linearly arranged, but only need to be adjacently positioned. FIGS. 6A to 6D are provided to illustrate that various symbol arrangements are contemplated herein, which do not necessarily need to be arranged in a matrix arrangement, but are not being provided to limit the various symbol arrangements that are applicable to the present disclosure.

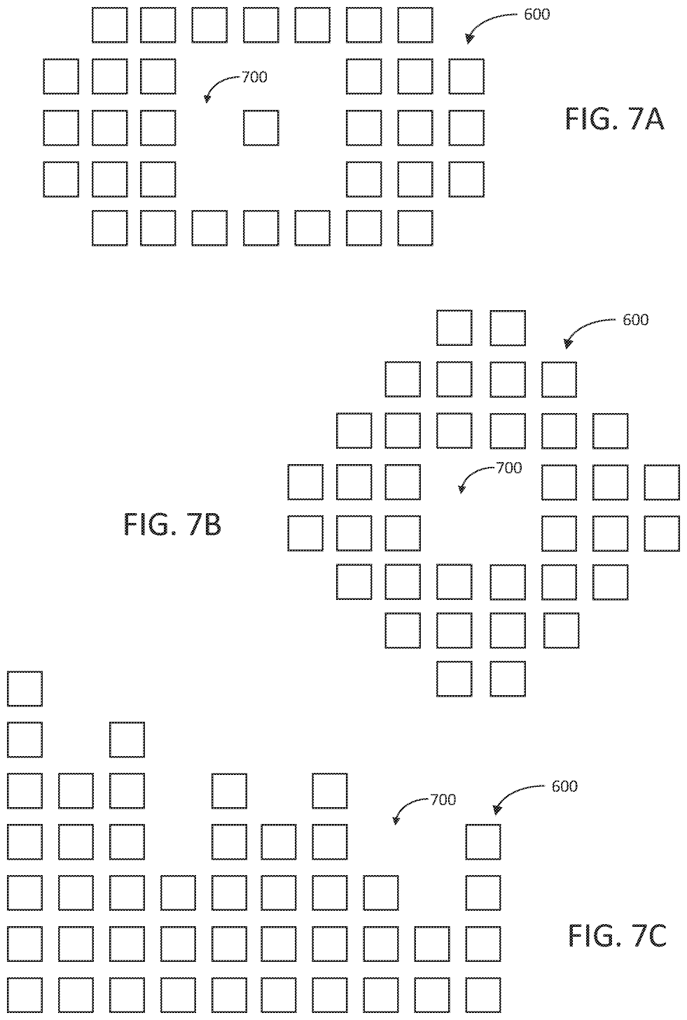

FIGS. 7A to 7B illustrate additional contemplated symbol arrangements as well as various play field arrangements, as contemplated herein. Each of FIGS. 7A to 7C illustrate different examples of a symbol arrangement of symbol positions 600 and void areas 700. In one embodiment, void area 700 acts to prevent symbols from cascading through them, and rather the symbols are forced to go around them. For example, if a symbol directly above a void area 700 were to cascade, it would be shown to move to the side of the void area 700 before cascading down. In another embodiment, void area 700 acts to hide the symbols that are behind it. For example, if a symbol directly above a void area 700 were to cascade, it would be shown to disappear behind the void area 700 until such time as it can cascade to below the void area. In a further embodiment, void area 700 is a temporary void area, which can be partially or wholly removed based on a proper match occurring directly adjacent to it. In another embodiment, void area 700 is non-temporary, and remains in place until the gaming system causes a different play field to be displayed. In still a further embodiment, void area 700 acts as a large symbol, and is subject to the same cascading actions that other symbols are subject to. For example, a void area 700 may cascade down into the symbol arrangement, and then cascade further down the symbol arrangement based on additional proper matches and symbol removals, and be released from the screen once it reaches the bottom, similar to how Reward symbols are released, as discussed above. FIGS. 7A to 7C are provided to illustrate that various symbol arrangements and various play fields are contemplated herein, but are not being provided to limit the various symbol arrangements or play fields that are applicable to the present disclosure.

FIGS. 6A to 6D and FIGS. 7A to 7C, individually and collectively, illustrate that various symbol arrangements and play fields are contemplated herein, and that accordingly, many different predefined match criteria and cascading movements and actions are additionally contemplated herein. Each of these, as well as others, may be utilized without departing from the present disclosure.

Reference to software in the present disclosure may encompass one or more computer programs that may encompass data, instructions, or both.

One or more tangible and non-transitory computer-readable media may store or otherwise embody software implementing particular embodiments. A tangible computer-readable medium may be any tangible medium capable of carrying, communicating, containing, holding, maintaining, propagating, retaining, storing, transmitting, transporting, or otherwise embodying software, where appropriate. A tangible computer-readable medium may be a biological, chemical, electronic, electromagnetic, infrared, magnetic, optical, quantum, or other suitable medium or a combination of two or more such media, where appropriate. Example tangible, non-transitory computer-readable media include, but are not limited to, application-specific integrated circuits (ASICs), compact discs (CDs), field-programmable gate arrays (FPGAs), floppy disks, floptical disks, hard disks, holographic storage devices, magnetic tape, caches, programmable logic devices (PLDs), random-access memory (RAM) devices, read-only memory (ROM) devices, semiconductor memory devices, and other suitable computer-readable media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose or specific-purpose computer system may execute software implementing particular embodiments, where appropriate.

Further examples are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the present disclosure.

What is claimed is:

1. A method comprising:
receiving an electronic communication that a physical indicia of monetary value was validly accepted by a bill acceptor and a credit is provided for wagering;
generating a first reward symbol based on a random number generator;
causing a display device to display a symbol arrangement of symbols including the first reward symbol as a part of the symbol arrangement, the symbol arrangement having a bottom;
receiving a desired move input from a user interface device;
determining whether the desired move input would cause a first plurality of symbols to meet a predefined match criteria;
when the desired move input would cause the first plurality of symbols to meet the predefined match criteria, causing a wager to be placed and causing the display device to display a move of at least two symbols in accordance with the desired move input;
determining a type of match for the first plurality of symbols;
causing the display device to display the removal of the first plurality of symbols;
when the type of match is determined to meet a predefined destroyer criteria, causing the display device to display the removal of at least one additional symbol;
after the removal of the at least one additional symbol, causing the display device to display a movement of symbols to reconstitute the symbol arrangement;
determining whether the first reward symbol has reached the bottom of the reconstituted symbol arrangement and thus is released;
when the first reward symbol was released, determining an award based on the wager and the first reward symbol; and
providing the award to the player.

2. The method of claim 1, further comprising:
determining whether the reconstituted symbol arrangement causes a second plurality of symbols to meet the predefined match criteria;
when the reconstituted symbol arrangement causes a second plurality of symbols to meet the predefined match criteria, determining the type of match for the second plurality of symbols and causing the display device to display the removal of the second plurality of symbols;
when the type of match is determined to meet the predefined destroyer criteria, causing the display device to display the removal of at least one additional symbol;
after the removal of the at least one additional symbol, causing the display device to display another reconstituted symbol arrangement;
determining whether a second reward symbol was released by the reconstituted symbol arrangement;
when the second reward symbol was released, determining a subsequent award based on the wager and the second reward symbol; and
providing the subsequent award to the player.

3. The method of claim 1, wherein the first reward symbol comprises a plurality of different symbols.

4. The method of claim 3, wherein each of the different symbols causes a different award to be determined.

5. The method of claim 1, further comprising:
determining whether the displayed symbol arrangement of symbols allows for any desired move input to cause any plurality of symbols to meet the predefined match criteria; and
when it is determined that any desired move input would not cause any plurality of symbols to meet the predefined match criteria, causing the display device to display the symbol arrangement with different symbols.

6. The method of claim 1, wherein the predefined match criteria requires at least three adjacently positioned like symbols, arranged in a row or a stack.

7. The method of claim 1, wherein the predefined destroyer criteria requires at least four adjacently positioned like symbols, arranged either vertically or horizontally.

8. The method of claim 1, wherein the predefined destroyer criteria requires that the first plurality of symbols be comprised of destroyer symbols.

9. The method of claim 1, wherein the symbol arrangement comprises a void area that acts to prevent symbols from cascading through respectively forced to go around the void area.

10. A gaming system comprising:
a display device;
a bill acceptor;
a user interface device;
at least on processor device; and
at least one memory device storing a plurality of instructions, which when executed by the at least one processor device, cause the at least one processor device to:
receive a confirmation from the bill acceptor that a physical indicia of monetary value was validly accepted and a credit is provided for wagering;
generate a first reward symbol based on a random number generator;
cause the display device to display a symbol arrangement of symbols including the first reward symbol as a part of the symbol arrangement, the symbol arrangement having a bottom;
receive from the user interface device a desired move input from a player;
determine whether the desired move input would cause a first plurality of symbols to meet a predefined match criteria;
when the desired move input would cause the first plurality of symbols to meet the predefined match criteria, cause a wager to be placed and cause the display device to display a move of at least two symbols in accordance with the desired move input;
determine a type of match for the first plurality of symbols;
cause the display device to display the removal of the first plurality of symbols;
when the type of match is determined to meet a predefined destroyer criteria, cause the display device to display the removal of at least one additional symbol;
after the removal of the at least one additional symbol, cause the display device to display a movement of symbols to reconstitute the symbol arrangement;
determine whether the first reward symbol has reached the bottom of the reconstituted symbol arrangement and thus is released;
when the first reward symbol was released, determine an award based on the wager and the first reward symbol; and
provide the award to the player.

11. The gaming system of claim 10, wherein the plurality of instructions further cause the at least one processor to:
determine whether the reconstituted symbol arrangement causes a second plurality of symbols to meet the predefined match criteria;
when the reconstituted symbol arrangement causes a second plurality of symbols to meet the predefined match criteria, determine the type of match for the second plurality of symbols and cause the display device to display the removal of the second plurality of symbols;
when the type of match is determined to meet the predefined destroyer criteria, cause the display device to display the removal of at least one additional symbol;
after the removal of the at least one additional symbol, cause the display device to display another reconstituted symbol arrangement;
determine whether a second reward symbol was released by the reconstituted symbol arrangement;
when the second reward symbol was released, determine a subsequent award based on the wager and the second reward symbol; and
provide the subsequent award to the player.

12. The gaming system of claim 10, wherein the first reward symbol comprises a plurality of different symbols.

13. The gaming system of claim 12, wherein each of the different symbols causes a different award to be determined.

14. The gaming system of claim 10, wherein the plurality of instructions further cause the at least one processor to:
determine whether the displayed symbol arrangement of symbols allows for any desired move input to cause any plurality of symbols to meet the predefined match criteria; and
when it is determined that any desired move input would not cause any plurality of symbols to meet the predefined match criteria, cause the display device to display the symbol arrangement with different symbols.

15. The gaming system of claim 10, wherein the predefined match criteria requires at least three adjacently positioned like symbols, arranged in a row or a stack.

16. The gaming system of claim 10, wherein the predefined destroyer criteria requires at least four adjacently positioned like symbols, arranged either vertically or horizontally.

17. The gaming system of claim 10, wherein the predefined destroyer criteria requires that the first plurality of symbols be comprised of destroyer symbols.

18. The gaming system of claim 10, wherein the symbol arrangement comprises a void area that acts to prevent symbols from cascading through respectively forced to go around the void area.
